(19) United States
(12) Patent Application Publication
(10) Pub. No.: US 2008/0073445 A1
(43) Pub. Date: Mar. 27, 2008

(54) CLUSTERED NOZZLE FOR GASIFICATION OR COMBUSTION AND ITS INDUSTRIAL APPLICATION

(76) Inventors: Zunhong YU, Shanghai (CN); Haifeng Liu, Shanghai (CN); Weifeng Li, Shanghai (CN); Zhenghua Dai, Shanghai (CN); Xueli Chen, Shanghai (CN); Guangsuo Yu, Shanghai (CN); Fuchen Wang, Shanghai (CN); Xin Gong, Shanghai (CN)

Correspondence Address: BLANK ROME LLP, 600 NEW HAMPSHIRE AVENUE, N.W., WASHINGTON, DC, 20037, US

(21) Appl. No.: 11/839,395

(22) Filed: Aug. 15, 2007

(30) Foreign Application Priority Data
Sep. 27, 2006 (CN) 200610116588.2

(51) Int. Cl. C10J 3/48; B05B 1/14; B05B 7/08

(52) U.S. Cl. 239/132; 239/398; 48/202

(57) ABSTRACT

This invention relates to a kind of clustered nozzle for gasification or combustion and its industrial applications. The clustered nozzle comprises a body case (5) and a plurality of nozzles (11) in the body case (5). The nozzle (11) includes an outer cannula (3) and an inner cannula (4) inside the outer cannula (3), a lower tubesheet (6), an upper tubesheet (7) and a cooling chamber (13). Compared with traditional coaxial double-pipe nozzles (e.g., dual-channel nozzles, triple-channel nozzles and multi-channel nozzles), the clustered nozzle for gasification or combustion has the following advantages: the length of combustion flame is shorter and the shape of flame is approximately rectangular, which help to protect the lower firebricks of the gasifier, thus prolonging their working life; the distribution of the residence time is narrower, which helps to increase the conversion rate of carbon; and the nozzle is properly-structured, which helps to prolong its working life.

### FIELD OF THE INVENTION

The present invention relates to equipments for converting raw materials, such as hydrocarbon materials into syngas, in particular, to a kind of nozzle for gasification or combustion.

### BACKGROUND OF THE INVENTION

The production of syngas is the public technology, source technology and key technology in producing synthetic ammonia (the precursor of urea), synthetic methanol, dimethyl ether, synthetic oil, hydrogen and sponge iron, and the nozzle is one of the critical technologies in producing syngas by means of entrained flow gasifier. Researches in gasification have been widely carried out and many patents have been issued. The typical patents include Shell's (ZL 90103807.5), Texaco's (ZL 94193847.6) and that of East China University of Science and Technology (ZL 98110616.1). But these technologies cannot satisfy the demand of industrial application from the point of enhancing the carbon conversion rate and the useful life of firebrick.

These technologies discussed above have shortcomings of low carbon conversion rate and short working life of firebrick. These deficiencies are related to the nozzle structures in addition to the processing factors. The traditional coaxial double-pipe external mixing type nozzle is a jet type nozzle, which produces a confined jet in a gasifier and engenders a circumfluence zone. The quantity of the circumfluence is multiple times of the quantity of jet.

$$\frac{{m}_{e}}{{m}_{0}} = 0.32 \frac{x}{{d}_{0}} - 1 \qquad ( 1 )$$

where mₑ is the mass flow rate of circumfluence; m₀ is the total mass flow rate of jet; x is the distance from the nozzle exit in axial direction (in meters); d₀ is the diameter of the nozzle exit (in meters) ([1] Ricou, F. P. and Spalding, D. B., Measurements of entrainments by axisymmetrical turbulent jets, J. Fluid Mech., 1961, 1, pp 21-32).

The semi-empirical relationship of the length of flame can be defined as follows:

$$L / d = 6 ( R + 1 ) {( \frac{{ρ}_{e}}{{ρ}_{F}} )}^{\frac{1}{2}} \qquad ( 2 )$$

where R is the mass ratio of air to fuel (for example, for CH₄, R=17.25); ρₑ is the fuel density; L (in meters) is the length of flame; ρ_{F} is the average density of the flame gas; d (in meters) is the nozzle diameter. ([2] Guenther, R., Gaswarme, 1966, 15, P376). According to equation (2), with the nozzle diameter decreasing, the length of flame will decrease. The quantity of circumfluence will reduce, too, according to equation (1).

### SUMMARY OF THE INVENTION

This invention aims to solve the deficiencies in the prior art by employing a novel clustered nozzle for gasification or combustion.

The clustered nozzle of the present invention comprises a body case and N nozzles in the body case, where N>1.

The nozzle comprises an outer cannula and an inner cannula located in the outer cannula, a lower tubesheet, an upper tubesheet and a cooling chamber. The outer cannula and the inner cannula are at the same level at their bottoms. The outer cannula is firmly connected to the lower tubesheet, and the inner cannula is firmly connected to the upper tubesheet. The lower tubesheet and the upper tubesheet are fixed to an inner wall of the body case.

The cooling chamber is fixed at an outlet of the nozzle.

In order to restrain the vibration of the nozzles while in operation, a strongback is fixed in a middle position inside the body case.

There are an inlet for coal water slurry or other hydrocarbon materials and a gasification agent inlet in the upper part of the body case. The inlet for coal water slurry or other hydrocarbon materials communicates to the inner cannula, and the gasification agent inlet communicates to the outer cannula.

The clustered nozzle for gasification or combustion of the invention can be installed in the entrained flow gasifier and is used to convert raw materials, such as hydrocarbons, into syngas. The processing steps include:

Hydrocarbon materials enter into the inner cannula through the inlet at a velocity in a range of 1-20 m/s;

Gasification agents enter into the outer cannula through the inlet at a velocity in a range of 10-200 m/s;

Cooling water enters into the cooling chamber at a flow rate in a range of 1-50 t/h;

The gasification agent is one of oxygen, carbon dioxide, steam, air or one of their mixtures;

The entrained flow gasifier operates at a pressure in a range of 1.0-10.0 MPa and at a temperature in a range of 1200° C.-1700° C.;

The hydrocarbon materials include coal, coal water slurry, natural gas, biomass and other materials containing hydrocarbon compounds.

Compared with traditional coaxial double-pipe nozzles, e.g., dual-channel nozzles, triple-channel nozzles and multi-channel nozzles, under the same operating condition, the clustered nozzle described above has the following advantages: the length of combustion flame is shorter and the shape of the flame is approximately rectangular, which helps to protect the firebricks in the lower portion of the gasifier and prolong their working life; the residence time distribution of the reactants is narrower, which helps to increase the carbon conversion rate; the nozzle is properly-structured, which helps to prolong its working life.

### BRIEF DESCRIPTION OF THE DRAWINGS

FIG. 1 shows the front cutaway view of an embodiment of the clustered nozzle for gasification or combustion of the present invention; and

FIG. 2 shows the cutaway view in the A-A direction of the embodiment shown in

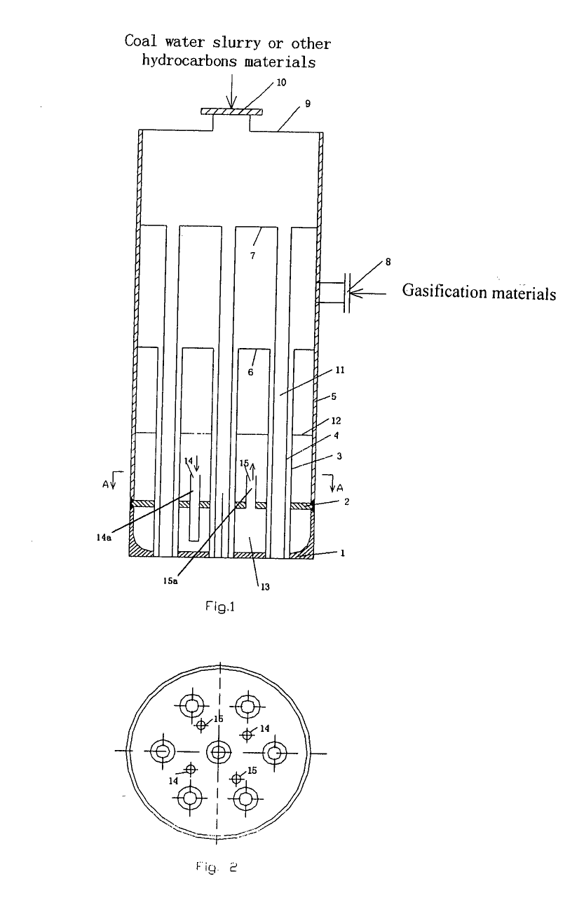

FIG. 1.

### DETAILED DESCRIPTION OF THE EMBODIMENTS

Referring to FIGS. 1 and 2, the clustered nozzle for gasification or combustion of an embodiment of the present invention comprises a body case 5 and N nozzles 11 in the body case 5. It is preferable to place the nozzles 11 vertically in the body case 5, and the axes of the nozzles 11 are preferably parallel to each other, where N>1, preferable N=2˜300.

Each of the nozzles 11 includes an outer cannula 3, an inner cannula 4 inside the outer cannula 3, a lower tubesheet 6, an upper tubesheet 7 and a cooling chamber 13.

The bottoms of the outer cannula 3 and the inner cannula 4 are at the same level. The outer cannula 3 is firmly connected to the lower tubesheet 6 and the inner cannula 4 is firmly connected to the upper tubesheet 7. The lower tubesheet 6 and the upper tubesheet 7 are firmly fixed to the inner wall of the body case 5. The outer cannula 3 and the inner cannula 4 are preferably coaxial.

The tube pitch between the outer cannulas 3 is 1d to 10d, where d is the outer diameter of the outer cannula 3.

The cooling chamber 13 is fixed at the outlet 17 of the nozzle 11. The cooling chamber 13 includes a U-shaped shell 1 fixed to the body case 5, a cover board 2 at the top of the U-shaped shell 1, an inlet of cooling water 14 and an inlet of backwater 15 which are located on the cover board 2. The water inlet pipe 14a is preferably inserted into the interior bottom surface of the U-shaped shell 1, and the water outlet pipe 15a is placed near the cover board 2, so that the cooling water in the cooling chamber 13 can flow with revolution to improve heat transfer.

In order to restrain the vibration of the nozzles in operation, a strongback 12 is fixed in the middle of the body case 5.

There are an inlet for coal water slurry or other hydrocarbon materials 10 and a gasification agent inlet 8 in the upper portion of the body case 5. The inlet for coal water slurry or other hydrocarbon materials 10 communicates to the inner cannula 4, and the gasification agent inlet 8 communicates to the outer cannula 3.

The higher the fixed location of the cover board 2 away from the bottom of the U-shaped shell 1 is, the better. It is preferable that L is approximately 40 mm in this invention.

The height range of the nozzle is about 100 mm to 3000 mm. The resistance will increase it the height is too large, and the flame will not be steady if the height is too small.

For example, in producing synthesis gas from coal water slurry, the coal water slurry flows towards the outlet of the nozzle 11 from the inlet 10 through the inner cannula 4 at a velocity of 1-20 m/s.

A gasification agent. e.g. oxygen (for the sake of safety, 5% water steam is allowed), is fed in through the inlet 8, and goes down along the annulus between the tube 3 and the tube 4 at a velocity in a range of 10 to 200 m/s. The two kinds of fluid. i.e. coal water slurry and oxygen, impinge with each other. The coal water slurry is atomized by the gas flow, with an average droplet diameter being 50 μm to 150 μm. The flame formed from the two kinds of fluid jets into the gasifier (gasification reactor), where gasification reactions (3), (4), (5) and (6) take place:
C+H₂O=CO+H₂ (3)
C+CO₂=2CO (4)
CO+H₂O=CO2+H₂ (5)

The volatile matters in the coal take pyrolytic reaction, such as:
C₂H₆=CH₄+C+H₂ (6)

The cooling water enters from the inlet 14 at a flow rate in a range of 1 to 50 m³/h.

### Example 1

A plant with an annual production capacity of 100,000 tons of methanol uses coal water slurry as a raw material, and adopts the clustered nozzle for gasification or combustion, as shown in FIGS. 1 and 2. The plant can produce 303 tons of methanol per day and dispose 400 tons of coal per day.

The structural parameters of the clustered nozzle for gasification or combustion are

The external diameter of the body case 5 is 260 mm; there are seven nozzles; the inner cannula diameter is 31×3 mm and the outer cannula diameter is 39.6x3 mm; the tube pitch between the outer cannulas 3 is 80 mm; the height of the nozzle H is 2000 mm; the distance L of the U-shaped shell 1 and the fixed position of cover board 2 is 40 mm;

In the inner cannula, the outlet velocity of the coal water slurry is approximately 2 m/s;

In the outer cannula, the outlet velocity of the gas is approximately 100 m/s;

In the gasifier, the pressure is 4.0 MPa and the gasifying temperature is 1300° C.; the cinders enter the chiller of the gasification reactor as a liquid melt; the resulting valid gas composition CO+H₂ is greater than or equal to 82%, and the carbon conversion rate is greater than or equal to 98%.

### Example 2

A plant of an annual capacity of 1.1 million tons of methanol, with coal water slurry as a raw material, can produce 3030 tons of methanol per day. In the plant, three gasifiers are needed, each one having a disposing capacity of 1500 tons of coal per day. The gasifiers adopt the clustered nozzle for gasification or combustion as shown in the FIGS. 1 and 2.

The structural parameters of the clustered nozzle for gasification or combustion are:

The external diameter of the body case 5 is 400 mm; there are 13 nozzles; the inner cannula diameter is 31×3 mm and the outer cannula diameter is 39.6x3 mm; the tube pitch between the outer cannulas 3 is 80 mm; the height H of the nozzle is 2000 mm; the distance L of the U-shaped shell 1 and the fixed position of cover board 2 is 40 mm;

In the inner cannula, the outlet velocity of the coal water slurry is approximately 4 m/s;

In the outer cannula, the outlet velocity of the gas is approximately 125 m/s;

In the gasification reactor, the pressure is 6.5 MPa and the gasifying temperature is 1400° C.; the cinders enter the chiller of the gasification reactor as a liquid melt: the resulting valid gas composition CO+H₂ is greater than or equal to 82%, and the conversion rate of carbon is greater than or equal to 98%.

1. A clustered nozzle for gasification or combustion, characterized in that it includes
a body case and a plurality of nozzles in the body case;
the nozzle includes an outer cannula and an inner cannula inside the outer cannula, a lower tubesheet, an upper tubesheet and a cooling chamber;
a bottom of the outer cannula is at a same level as a bottom of the inner cannula; the outer cannula is firmly connected to the lower tubesheet and the inner cannula is firmly connected to the upper tubesheet, and the lower tubesheet and the upper tubesheet are fixed in an inner wall of the body case; the nozzles are placed vertically in the body case, and axes of the nozzles are parallel to each other, and the outer cannula and the inner cannula are coaxial;
the cooling chamber is fixed at an outlet of the nozzle; a strongback is fixed in a middle position inside the body case so as to restrain the vibration of the nozzles in operation;
an inlet for coal water slurry or other hydrocarbon materials and a gasification agent inlet are set in an upper portion of the body case; the inlet for coal water slurry or other hydrocarbon materials communicates to the inner cannula, and the gasification agent inlet (communicates to the outer cannula.

2. The clustered nozzle for gasification or combustion according to claim 1, wherein a tube pitch between the outer cannulas is in a range of 1d to 10d, where d is an outer diameter of the outer cannula.

3. The clustered nozzle for gasification or combustion according to claim 1, wherein the cooling chamber includes a U-shaped shell which is fixed to the body case, a cover board which is located at a top of the U-shaped shell, an inlet of cooling water and an inlet of backwater which are located on the cover board.

4. The clustered nozzle for gasification or combustion according to claim 3, wherein the water inlet pipe is inserted into an interior bottom of the U-shaped shell and the water outlet pipe is near the cover board.

5. The clustered nozzle for gasification or combustion according to claim 3, wherein the U-shaped shell and the cover board are firmly connected at a position where L is approximately 40 mm.

6. The clustered nozzle for gasification or combustion according to claim 1, wherein a height H of the nozzle is in a range of 100 mm to 3000 mm and an amount N of the nozzles is in a range of 2 to 300.

7. A method of using the clustered nozzle for gasification or combustion according to claim 1, wherein it is fixed in an entrained flow gasifier and is used to convert raw materials into syngas, the processing steps include:
the hydrocarbon materials enter into the inner cannula from the inlet at a velocity in a range of 1-20 m/s;
one or more of the gasification agents enter into the outer cannula from the inlet at a velocity in a range of 10-200 m/s;
the cooling water enters into the cooling chamber 3 at a flow rate in a range of 1-50 t/h;
said gasification agents are selected from oxygen, carbon dioxide, steam, air or their mixtures;
the entrained flow gasifier operates at a pressure in a range of 1.0 MPa ˜10.0 MPa and at a temperature in a range of 1200° C. ˜1700° C.;
said hydrocarbon materials include coal, coal water slurry, natural gas, biomass and other materials containing hydrocarbon compounds.
